(19) United States
(12) Patent Application Publication
(10) Pub. No.: US 2026/0021728 A1
(43) Pub. Date: Jan. 22, 2026

(54) AUTOMATIC CHARGING ROBOT AND CHARGING SYSTEM

(71) Applicant: TOYOTA JIDOSHA KABUSHIKI KAISHA, Toyota-shi Aichi-ken (JP)

(72) Inventors: Hironaga ONO, Toyota-shi Aichi-ken (JP); Ritsu NISHIMURA, Nagoya-shi Aichi-ken (JP); Hiroaki NISHINO, Toyota-shi Aichi-ken (JP); Yohei ONO, Nisshin-shi Aichi-ken (JP); Ryohei CHINO, Nisshin-shi Aichi-ken (JP); Shimpei ISOBE, Toyota-shi Aichi-ken (JP); Manabu HIROSE, Okazaki-shi Aichi-ken (JP)

(73) Assignee: TOYOTA JIDOSHA KABUSHIKI KAISHA, Toyota-shi Aichi-ken (JP)

(21) Appl. No.: 19/268,158

(22) Filed: Jul. 14, 2025

(30) Foreign Application Priority Data
Jul. 19, 2024 (JP) 2024-115774

(51) Int. Cl. B60L 53/35; B60L 53/16; B60L 53/18; B60L 53/60; H01R 43/26

(52) U.S. Cl. CPC B60L 53/35; B60L 53/16; B60L 53/18; B60L 53/60; H01R 43/26

(57) ABSTRACT

An automatic charging robot includes: an arm mechanism for gripping a charging connector connected to a charging device with a charging cable; a control device for automatically performing control for operating the arm mechanism; and a holding member for holding the charging cable along an arm portion of the arm mechanism.

### CROSS-REFERENCE TO RELATED APPLICATION(S)

The present application claims priority to and incorporates by reference the entire contents of Japanese Patent Application No. 2024-115774 filed in Japan on Jul. 19, 2024.

### BACKGROUND

The present disclosure relates to an automatic charging robot and a charging system.

Japanese Laid-open Patent Publication No. 2020-072625 discloses a charging system including a charging device in which a charging cable having a charging plug is connected to one or more apparatus main bodies, grasp any charging plug provided in the charging device, with respect to the charging port of the vehicle located in the charging space, the charging system comprising an arm mechanism for automatically performing the insertion and removal of the charging plug, is disclosed.

### SUMMARY

There is a need for providing an automatic charging robot and a charging system that can inhibit the charging cable from contacting the vehicle.

According to an embodiment, an automatic charging robot includes: an arm mechanism for gripping a charging connector connected to a charging device with a charging cable; a control device for automatically performing control for operating the arm mechanism; and a holding member for holding the charging cable along an arm portion of the arm mechanism.

According to an embodiment, an automatic charging robot includes: an arm mechanism for gripping a charging connector connected to a charging device with a charging cable; a control device for automatically performing control for operating the arm mechanism; and a hook member for hooking the charging cable to the arm mechanism.

According to an embodiment, a charging system includes: a charging device in which a charging connector is connected with a charging cable; and an automatic charging robot including: an arm mechanism for gripping the charging connector, and a control device for automatically performing control for operating the arm mechanism. Further, the charging cable is provided with a tensioning device for applying tension to the charging cable.

### BRIEF DESCRIPTION OF THE DRAWINGS

FIG. 1 is a block diagram illustrating a schematic configuration of a charging system according to a first embodiment;

FIG. 2 is a perspective view illustrating a schematic configuration of a charging system according to the first embodiment;

FIG. 3 is a plan view illustrating a schematic configuration of the charging system according to the first embodiment;

FIG. 4 is a flowchart illustrating an overall flow of a charging method the charging system according to the first embodiment executes;

FIG. 5 is a side view illustrating a schematic configuration of the charging system according to the first embodiment;

FIG. 6 is a side view illustrating a schematic configuration of a charging system according to a second embodiment;

FIG. 7A is a side view illustrating a main part of a schematic configuration of a charging system according to a third embodiment; and

FIG. 7B is another side view illustrating a main part of a schematic configuration of the charging system according to the third embodiment

### DETAILED DESCRIPTION

In the related-art, the charging cable may contact the vehicle in the operation of plugging into the charging port of the vehicle by grasping the charging plug provided in the charging device and the operation returning the charging plug to the charging device by removing the charging plug from the charging port of the vehicle.

### First Embodiment

Hereinafter, a first embodiment of a charging system equipped with an automatic charging robot according to the present disclosure will be described. Note that the present disclosure is not limited by this embodiment.

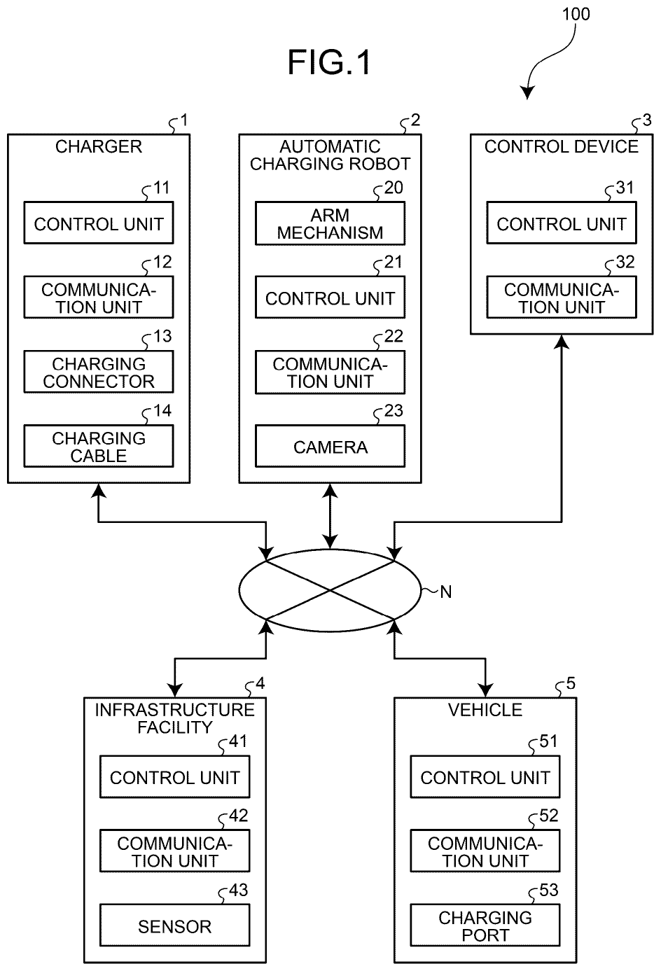

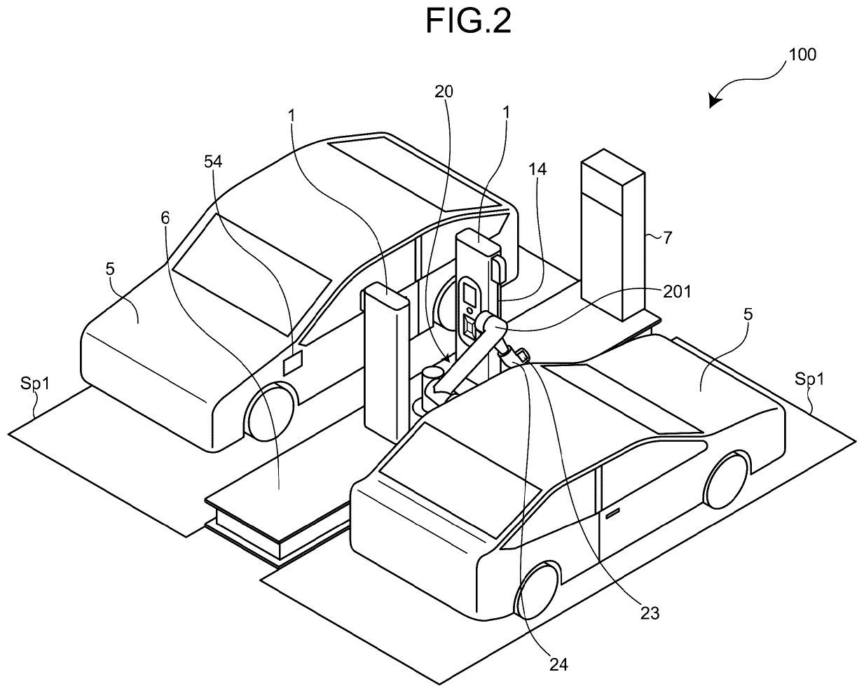

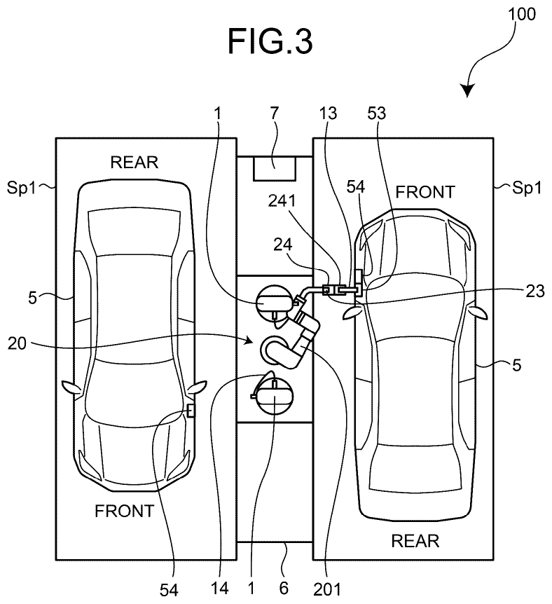

FIG. 1 is a block diagram illustrating a schematic configuration of a charging system 100 according to the first embodiment. FIG. 2 is a perspective view illustrating a schematic configuration of a charging system 100 according to the first embodiment. FIG. 3 is a plan view illustrating a schematic configuration of a charging system 100 according to the first embodiment.

The charging system 100 according to the first embodiment, for example, by using a charger installed in a parking lot, is for charging a plurality of vehicles at the same time. The charging system 100 according to the first embodiment, as illustrated in FIG. 1, has a charger 1, an automatic charging robot 2, a control device 3, an infrastructure facility 4, and a vehicle 5. The charger 1, the automatic charging robot 2, the control device 3, the infrastructure facility 4 and the vehicle 5 are provided with respective communication functions, and they communicate with each other through a network N, and are configured to be able to exchange various types of information. The network N is composed of, for example, the Internet line network, or a cellular phone line network.

The charger (charging station, charging post) 1 is a charging device for supplying power to the vehicle 5 to be charged. The charger 1, as illustrated in FIGS. 2 and 3, is installed on the frame 6. Further, the charger 1 is connected to the control panel 7. The control panel 7 is connected to, for example, a substation facility (cubicle) for transforming power from the power plant.

The charger 1, as illustrated in FIG. 1, includes a control unit 11, a communication unit 12, a charging connector 13, and a charging cable 14.

The control unit 11 includes, for example, a processor made of a Central Processing Unit (CPU) or the like, a Random Access Memory (RAM) and a memory (a main storage unit) consisting of such a Read Only Memory (ROM). The control unit 11, according to an instruction from the control unit 3, supplies power to the vehicle 5 to be charged.

The communication unit 12 includes, for example, a Local Area Network (LAN) interface board, a wireless communication circuitry for wireless communication, and the like. The communication unit 12 communicates with, for example, the automatic charging robot 2, and the control device 3 through the network N.

The charging connector (charging gun, charging plug) 13 is for supplying power to the vehicle 5 to be charged. The charging connector 13 is engaged with the side surface of the charger 1 during non-charging. Then, the charging connector 13, when the charging to the vehicle 5 is started, is grasped by the automatic charging robot 2 of the fixed type, and is inserted into the charging port 53 of the vehicle 5. In this state, through the charging connector 13, power is supplied from the charger 1 side to the vehicle 5 side. Thereafter, when the charging of the vehicle 5 is completed, the charging connector 13 is again grasped by the automatic charging robot 2, and, after being withdrawn from the charging port 53 of the vehicle 5, is engaged with the side surface of the charger 1.

The infrastructure facility 4, as illustrated in FIG. 1, includes a control unit 41, a communication unit 42, and a sensor 43. The control unit 41 includes, for example, a processor made of a Central Processing Unit (CPU) or the like, a Random Access Memory (RAM) and a memory (a main storage unit) consisting of such a Read Only Memory (ROM). The communication unit 42 includes, for example, a Local Area Network (LAN) interface board, a wireless communication circuitry for wireless communication, and the like.

The vehicle 5, as illustrated in FIG. 1, includes a control unit 51, a communication unit 52, and a charging port 53. The control unit 51 includes, for example, a processor made of a Central Processing Unit (CPU) or the like, a Random Access Memory (RAM) and a memory (a main storage unit) consisting of such a Read Only Memory (ROM). The communication unit 52 includes, for example, a Local Area Network (LAN) interface board, a wireless communication circuitry for wireless communication, and the like.

In FIGS. 2 and 3, an example in the case where one charging connector 13 is provided for one charger 1 is illustrated. But, a plurality of charging connectors 13 may be provided for one charger 1.

The charging cable 14 is provided between the charging connector 13 and the charger 1 (charger body). The charging cable 14, regardless of the position of the charging port 53 in the vehicle 5, is constituted by a length capable of inserting the charging connector 13 into the charging port 53. For example, in FIG. 3, a case is illustrated in which the charging port 53 is disposed on the left front of the vehicle 5. However, depending on the type of vehicle, the charging port 53 may be disposed on one of the left front side, the left rear side, the center front side, or the center rear side of the vehicle 5. Therefore, even though the charging port 53 of the vehicle 5 is arranged in any of the left front side, the left rear side, the center front side, and the center rear side, the charging cable 14, the left front of the charging port 53 of the vehicle 5, the charging connector 13 is configured in a length that can be inserted.

Incidentally, depending on the vehicle type of the vehicle 5, the charging port 53 may be arranged in the right front side or the right rear side of the vehicle 5. In such a case, for example, in FIG. 3, the vehicle 5 is parked in the direction opposite to the direction of FIG. 3 in the left and the right charging spaces Sp1 so that each of the charging ports 53 of the vehicles 5 faces the charger 1. Specifically, for example, the vehicle 5 on the right side of FIG. 3 is parted in a manner that the vehicle front is directed to the lower paper side, the vehicle rear is directed to the upper paper side in the charge space Sp1. On the other hand, the vehicle 5 on the left side of FIG. 3 is parted in a manner that the vehicle rear is directed to the lower paper side and the vehicle front is directed to the upper paper side in the charge space Sp1.

The automatic charging robot 2, when performing charging from the charger 1 to the vehicle 5, is for performing the insertion and removal to the charging port 53 by gripping the charging connector 13 automatically.

The automatic charging robot 2 includes, as illustrated in FIG. 1, an arm mechanism 20, a control unit 21, a communication unit 22, a camera 23, and a driving device.

The arm mechanism 20 has a base end portion, which is installed and fixed on the frame 6. The arm mechanism 20 is provided on the arm tip 24, which is an arm portion having a plurality of joint portions and is a distal end portion of the robot arm 201, and has a robot hand 241 to grip the charging connector 13.

The control unit 21 is a control device having, for example, a processor made of a CPU, and a memory (main storage unit) consisting of a RAM and a ROM. The control unit 21, based on an instruction from the control device 3, automatically controls the drive unit, and grasps the charging connector 13 by the robot hand 241 of the arm mechanism 20, and perform the insertion of the charging connector 13 to the charging port 53 and the removal of the charging connector 13 from the charging port 53. Namely, the control unit 21, based on an instruction from the control device 3, automatically performs control for operating the arm mechanism 20. Further, the control unit 21, for example, is disposed in the proximal end portion of the arm mechanism 20.

Further, the control unit 21, when inserting the grasped charging connector 13 to the charging port 53, for example, based on the image captured by the camera 23 installed at the tip of the automatic charging robot 2, specifies (detects) the position of the charging port 53 and the distance to the charging port 53 (the distance between the charging connector 13 and the charging port 53). The shape of the charging port 53 of the vehicle 5 has been normalized. Therefore, the position of the charging port 53 can be identified by performing pattern matching based on the image of the charging port 53 captured by the camera 23. Further, the distance from the charging connector 13, which the automatic charging robot 2 is gripping, to the charging port 53 can be specified by using a 3D (three-dimensional) camera as the camera 23 to detect the information in the depth direction.

The communication unit 22 is composed of, for example, a LAN interface board, a wireless communication circuitry for wireless communication, and the like. The communication unit 22 communicates with the charger 1 and the control device 3 through the network N, for example. Further, the communication unit 22, for example, is disposed in the proximal end portion of the arm mechanism 20.

The camera 23 is for imaging the charging port 53. The camera 23 is provided at the tip of the automatic charging robot 2 (arm mechanism body). The camera 23 is, for example, is communicatively configured to between the control unit 21 via the communication cable. Further, as the camera 23, a 3D camera capable of acquiring information in the depth direction may be used.

The controller 3 is for controlling the charger 1, the automatic charging robot 2 and a plurality of vehicles 5. The control device 3 performs, for example, charging control of the charger 1, control of the operation of the automatic charging robot 2, control of the infrastructure facility 4, running control of the vehicle 5 and the like. The controller 3 may be implemented, for example, by a general-purpose computer such as a workstation or a personal computer, or by a server located on a cloud. Incidentally, the control device 3 may be constituted by separate hardware in accordance with the control target (charger 1, automatic charging robot 2, infrastructure facility 4, and vehicle 5). Further, among the functions of the control device 3, a function of performing charging control of the charger 1 may be performed by the control panel 7.

The control device 3, as illustrated in FIG. 1, includes a control unit 31 and a communication unit 32.

The control unit 31 includes, for example, a processor made of a CPU, and a memory (main storage unit) made of a RAM or a ROM. The following describes the specific processing contents of the control unit 31.

The control unit 31 performs travel control of the vehicle 5 based on the information acquired from the infrastructure facility 4 (e.g., position information of the vehicle 5, etc.). For example, the control unit 31 receives the charging reservation of the vehicle 5 from the user of the vehicle 5 (e.g., the driver). The charging reservation may be accepted based on information input to the information terminal carried by the user (e.g., a smartphone connected to the network N), or the user may be accepted based on information input to the in-vehicle terminal (e.g., a car navigation connected to the network N).

When the order of charging of the vehicle 5 is approaching, by using the positional information of the vehicle 5 acquired from the infrastructure facility 4, the control unit 31 causes the vehicle 5 to automatically drive from the parking space in which the vehicle 5 is parked to the standby space to automatically park. Thus, by waiting to move the vehicle 5 to be charged to the standby space in advance, it is possible to minimize the replacement time of the vehicle 5 to perform charging and it is also possible to improve the operation rate of the charger 1.

Subsequently, when the order of charging the vehicle 5 arrives, by using the positional information of the vehicle 5 acquired from the infrastructure facility 4, the control unit 31 causes the vehicle 5 to automatically travel from the standby space to the charging space Sp1 and automatically park. Then, the control unit 31 is caused to grip the charging connector 13 by the automatic charging robot 2, the charging connector 13 which is gripped is inserted into the charging port 53 by the automatic charging robot 2, to start charging by the charger 1.

Subsequently, when the charging of the vehicle 5 is completed, the control unit 31 causes the automatic charging robot 2 to grasp the charging connector 13 again, and further causes the automatic charging robot 2 to remove the charging connector 13 from the charging port 53. Subsequently, the control unit 31 uses the positional information of the vehicle 5 acquired from the infrastructure facility 4 to cause the vehicle 5 to automatically travel from the charging space Sp1 to the standby space so as to automatically park.

The control unit 31, when causing the vehicle 5 to park in the charging space Sp1, causes the vehicle to park in a manner that the charging port 53 faces the charger 1. For example, when charging the vehicle 5 on which the charging port 53 is disposed on the left front, as illustrated in FIG. 3, the vehicle 5 is parked in the charging space Sp1 which is on the right side of the charger 1, so that the charging port 53 is on the left, in a manner that the vehicle front is toward the upper side of FIG. 3, and, the vehicle rear is toward the lower side of FIG. 3. In contrast, in the charging space Sp1 on the left side of the charger 1, the vehicle 5 is parked in the charging space Sp1 which is on the left side of the charger 1, so that the charging port 53 is on the right, in a manner that the vehicle rear is directed toward the upper side of FIG. 3, and, the vehicle front is directed toward the lower side of FIG. 3.

Incidentally, depending on the vehicle type of the vehicle 5, opposite to the case of FIG. 3, there is a case where the charging port 53 is disposed on the right front or right rear of the vehicle 5. In this case, for example, in the example of two vehicles 5 illustrated in FIG. 3, in the charging space Sp1 on the right side of the charger 1, the vehicle 5 is parked so that the charging port 53 is on the left, in a manner that the vehicle front is directed toward the lower side of FIG. 3, and, the vehicle rear is directed toward the upper side of FIG. 3. Conversely, in the charging space Sp1 on the left side of the charger 1, the vehicle 5 is parked so that the charging port 53 is on the right, in a manner that the vehicle front is directed toward the upper side of FIG. 3, and, the vehicle rear is directed toward the lower side of FIG. 3.

The control unit 31, by using a single automatic charging robot 2, can perform control to charge two or more vehicles 5 at the same time. In this instance, the control unit 31 moves a first vehicle 5 (hereinafter, referred to as “vehicle A”) to a predetermined position (charge space Sp1 on the right side of FIG. 3). Subsequently, the control unit 31 causes the automatic charging robot 2 to grip the charging connector 13 of a first charger 1 (charger 1 on the upper side of the paper). Subsequently, the control unit 31 performs control to cause the charging connector 13 which is gripped by the automatic charging robot 2, is inserted into the charging port 53 of the vehicle A to start the charging of the vehicle A.

Subsequently, the control unit 31 moves a second vehicle 5 (hereinafter, referred to as “vehicle B”) to a predetermined position (charge space Sp1 on the left side of the paper surface). Subsequently, the control unit 31 causes the automatic charging robot 2 to grip the charging connector 13 of a second charger 1 (charger 1 of the paper surface lower). Subsequently, the control unit 31, during charging of the vehicle A, performs control so that the charging connector 13 which is grasped by the automatic charging robot 2 is inserted into the charging port 53 of the vehicle B to start the charging of the vehicle B.

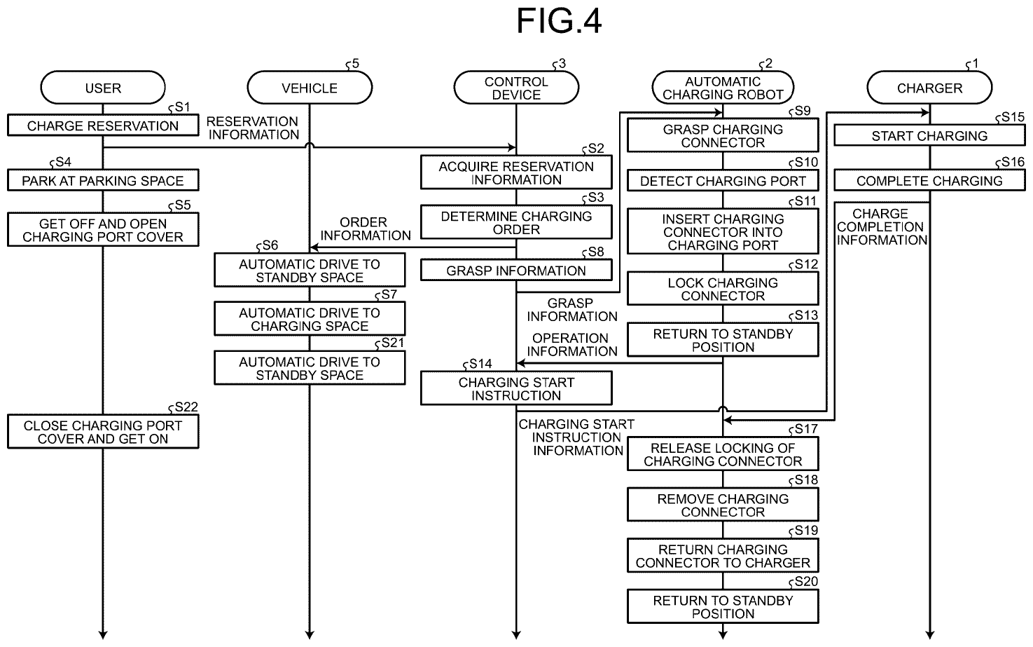

FIG. 4 is a flowchart illustrating an overall flow of a charging method that is executed by the charging system 100 according to the first embodiment.

First, the user makes a charge reservation (step S1). The charging reservation may be performed, for example, through an information terminal possessed by the user (e.g., a smartphone connected to the network N, etc.), or may be performed through an in-vehicle terminal (e.g., a car navigation system connected to the network N, etc.).

Subsequently, the control device 3 acquires the reserved information of the charge from the above-described information terminal or the in-vehicle terminal or the like (step S2). This reservation information includes information necessary for charging the vehicle 5 by the charger 1.

The reservation information includes, for example, information for specifying a user (for example, a user ID, etc.), information on the transmission date and time of the charging reservation, and information on the date and time that the charging is desired. The reservation information also includes information for specifying the vehicle 5 (e.g., vehicle number, etc.), information about the position of the charging port 53 of the vehicle 5, information about the remaining battery capacity of the vehicle 5 (SOC: State Of Charge), and the present position of the vehicle 5. Incidentally, the information about the position of the charging port 53 is the information indicating, for example, which of the left front, the left rear, the right front, and the right rear areas the charging port 53 is located.

Subsequently, the control device 3 determines the order of charging the vehicles 5 that have received the reservation (step S3). In step S3, for example, the control device 3 determines the order of charging the vehicles 5 based on the number of other vehicles 5 that have received the charging reservation at the same time or before or after that time and a predicted time period until the charging completion based on the remaining battery capacity of the other vehicles 5. Further, in step S3, the control device 3 transmits the information about the determined order (order information) to the vehicle 5 (and the information terminal of the user and the in-vehicle terminal).

Subsequently, the user parks the vehicle 5 in the parking space of the parking lot (parking lot where the charger 1 is installed) (step S4). Subsequently, after getting out of the vehicle 5, the user opens the charging lid 54 and the charging port cover (step S5), and leaves the parking space.

Subsequently, the vehicle 5 automatically travels from the parking space to the standby space based on an instruction of the control device 3 (step S6). Then, when the order of charging arrives, the vehicle 5 automatically travels from the standby space to the charging space Sp1 on the basis of an instruction of the control device 3 (step S7).

When the vehicle 5 is stopped in the charging space Sp1, the control device 3, to the automatic charging robot 2, transmits an instruction to grip the charging connector 13 (grasp instruction) (step S8).

In response to this, the automatic charging robot 2 grasps the charging connector 13 by the arm mechanism 20 (step S9), to move the charging connector 13 to the vicinity of the charging port 53.

Subsequently, the automatic charging robot 2, for example, by pattern matching based on the image information of the charging port 53 captured by the camera 23, detects the position of the charging port 53 (step S10), and inserts the charging connector 13 into the charging port 53 (step S11).

Subsequently, the automatic charging robot 2 locks the charging connector 13 to the charging port 53 (vehicle 5) by a locking mechanism or the like, so that the charging connector 13 does not come off from the charging port 53 (step S12). Then the automatic charging robot 2 releases the grip of the charging connector 13 by the arm distal end portion 24 of the arm mechanism 20 to return to a predetermined standby position (step S13). Incidentally, the term “predetermined standby position” refers to, for example, as illustrated in FIG. 1, a state in which the whole of the arm mechanism 20 is within the range of the frame 6 (the state that the arm mechanism 20 does not protrude from the frame 6) and the like. Further, in step S13, the automatic charging robot 2 transmits the information indicating the current operation status of the arm mechanism 20 and the charging connector 13 (e.g., the presence or absence of the lock of the current position and the charging connector 13 of the arm mechanism 20, etc.) to the control device 3.

Subsequently, the control device 3 transmits the information for instructing the start of charging from the charger 1 to the vehicle 5 (charging start instruction information) to the charger 1 (step S14). Subsequently, the charger 1 starts charging the vehicles 5 (stepped S15). Subsequently, when the charging of the vehicle 5 is completed (step S16), the charger 1 transmits information indicating that the charging is completed (charging completion information) to the automatic charging robot 2.

Subsequently, the automatic charging robot 2 unlocks the charging connector 13 (step S17). Then, the auto charging robot 2 withdraws charging connector 13 from the charging port 53 by the arm distal end portion 24 of the arm mechanism 20 (step S18). Subsequently, the automatic charging robot 2 returns the withdrawn charging connector 13 to a predetermined position of the charger 1 (e.g., the side of the charger 1) (step S19). Then, the automatic charging robot 2 releases the grip of the charging connector 13 by the arm distal end portion 24 to return the arm mechanism 20 to a predetermined standby position (step S20).

Subsequently, based on an instruction of the control device 3, the vehicle 5 automatically travels from the charge space Sp1 to the standby space (step S21). Subsequently, the user closes the charging port cover and the charging lid 54 in the standby space, rides on the vehicle 5 (step S22), and exits the parking lot.

Although not illustrated in FIG. 4, when the vehicle 5 automatically travels in steps S6, S7, and S21, by the continuous communications between the control device 3 and the vehicle, the automatic travel is realized. In this instance, based on, for example, the information acquired from the infrastructure facility 4, the control device 3 specifies the position of the vehicle 5 sequentially transmits the position of the standby space, the charging space Sp1, and such travel routes to the position of the standby space and the charging space Sp1 to vehicle 5. Thus, the control device 3 controls the travel of the vehicle 5 in the parking lot.

In the charging system 100 according to the first embodiment described above, a single fixed-type arm mechanism 20 operates a plurality of charging connector 13 and charges a plurality of vehicles 5 simultaneously. At that time, since the arm mechanism 20 itself could not be moved, by moving the vehicle 5 during charging while inserting the charging connector 13, it is possible to charge a plurality of vehicles 5 simultaneously.

Thus, according to the charging system 100 according to the first embodiment, regardless of the position of the charging port 53 of the vehicle 5 and the type of parking lot, it is possible to simultaneously charge the two or more vehicles 5 by a simple configuration, and it is possible to increase the rotation rate of charging. As a result, it is possible to shorten the waiting time for charging for the user, and it is possible to improve the profitability when developing the charging to the vehicle 5 as a business. Further, by using the automatic moving and automatic parking of the vehicle 5 to charge the vehicle 5, it is not necessary to wait for charging for the user, and thus, convenience of the user is improved.

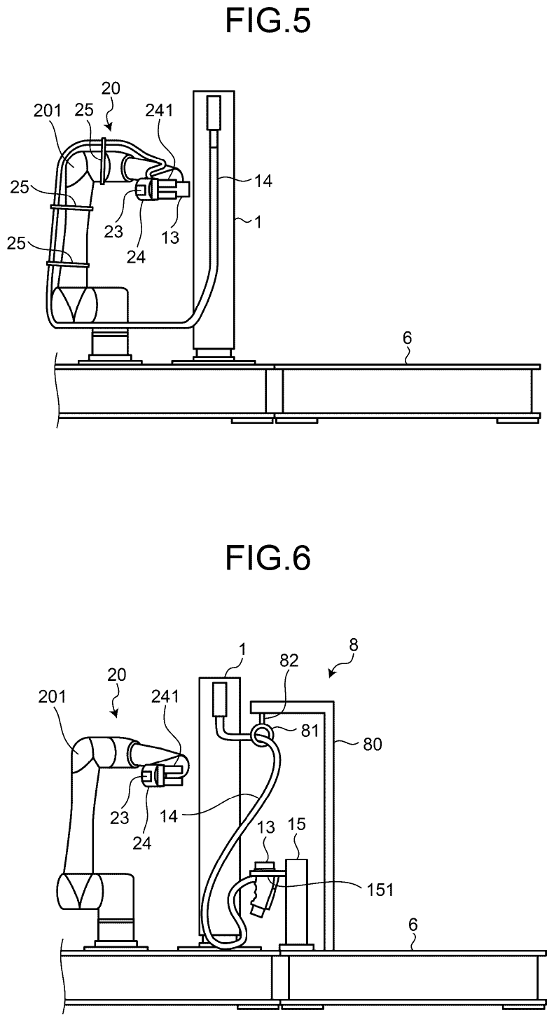

FIG. 5 is a side view illustrating a schematic configuration of a charging system 100 according to the first embodiment.

In the charging system 100 according to the first embodiment, as illustrated in FIG. 5, the automatic charging robot 2 has a restraining band 25, which is a plurality of holding members for holding and restraining the charging cable 14 along the robot arm 201 of the arm mechanism 20. The restraint band 25 is made of, for example, a metal or resin, and holds and restrains the charging cable 14 to the robot arm 201 by tightening in an annular state while sandwiching the charging cable 14 over the outer periphery of the robot arm 201. Incidentally, it is noted that it is not limited to the case where the restraining band 25 sandwiches the charging cable 14 over the outer periphery of the robot arm 201 to restrain and holed so as to closely contact the robot arm 201 and the charging cable 14. For example, even if there is a gap between the robot arm 201 and the charging cable 14, the restraint band 25 may restrict the movement of the charging cable 14 in the direction away from the robot arm 201 within a predetermined range so as to hold and restrain the charging cable 14.

In the charging system 100 according to the first embodiment, the plurality of restraining bands 25 hold and restrain the charging cable 14 in a manner that the charging cable 14 is provided along with the robot arm 201 of the arm mechanism 20 of the automatic charging robot 2. Thus, in the operations of grasping the charging connector 13 and plugging into the charging port 53 and in the operations of removing the charging connector 13 from the charging port 53 and returning the charging connector 13 to a predetermined position such as a side surface of the charger 1, the movement of the charging cable 14 away from the robot arm 201 can be regulated so that the slack is within a predetermined range, and it is possible to suppress the charging cable 14 from contacting the vehicle 5.

### Second Embodiment

Hereinafter, a second embodiment of a charging system provided with an automatic charging robot according to the present disclosure will be described. Incidentally, the description of the same configuration as the first embodiment in the present embodiment will be appropriately omitted.

FIG. 6 is a side view illustrating a schematic configuration of a charging system 100 according to a second embodiment.

In the charging system 100 according to the second embodiment, as illustrated in FIG. 6, on the opposite side of the automatic charging robot 2 with respect to the charger 1, a tension applying device 8 for applying tension to the charging cable 14 is provided. The tension applying device 8 includes, an upside-down L-shaped strut 80 which is installed and fixed on the frame 6, an annular tensioner 81 for applying tension by pulling the charging cable 14, and a holding member 82 which holds the tensioner 81 in a manner that the tensioner 81 is held to hang the strut 80. The charging cable 14, having one end side connected to the charger 1, has the other end which is connected to the charging connector 13 via the tensioner 81. The charging connector 13 is detachably held in the holder 151 of the connector stand 15 provided below the tensioner 81 on the frame 6.

In the charging system 100 according to the second embodiment, a tension is applied by pulling the charging cable 14 by the tension applying device 8 (tensioner 81), so that the excess length of the charging cable 14 is not longer than necessary. Thus, in the charging system 100 according to the second embodiment, in the operations of, for example, inserting the charging port 53 by gripping the charging connector 13 and removing the charging connector 13 from the charging port 53 and returning the charging connector 13 to a predetermined position such as the side surface of the charger 1, it is possible to reduce the slack of the charging cable 14 and the charging cable 14 can be suppressed from contacting the vehicle 5.

### Third Embodiment

Hereinafter, a third embodiment of a charging system provided with an automatic charging robot of the present disclosure will be described. Incidentally, the description of the same configuration as the first and second embodiments in the present embodiment will be appropriately emitted.

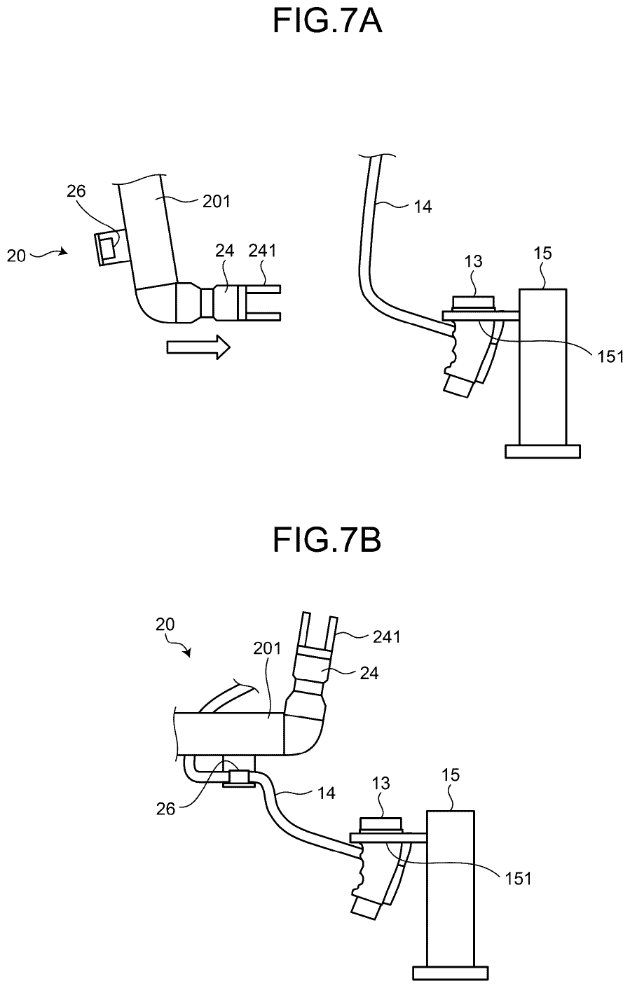

FIGS. 7A and 7B are side views illustrating a main part of a schematic configuration of a charging system 100 according to the third embodiment.

In the charging system 100 according to the third embodiment, as illustrated in FIGS. 7A and 7B, the robot arm 201 of the arm mechanism 20 of the automatic charging robot 2 is provided with a hook member 26 capable of hooking the charging cable 14. In the charging system 100 according to the third embodiment, as illustrated in FIG. 7A, the charging connector 13 is detachably held to the holder 151 of the connector stand 15. Accordingly, the charging cable 14 is hooked by the hook member 26 of the arm mechanism 20 in a defined shape formed in a defined shape and hangs from the charger 1.

Then, as illustrated in FIG. 7B, before gripping the charging connector 13 by the robot hand 241 provided on the arm distal end portion 24 of the arm mechanism 20, so as to hook the charging cable 14 to the hook member 26, the automatic charging robot 2 by controlling the driving device by the control unit 21, the robot arm 201 of the arm mechanism 20 is moved. Further, for example, after returning the charging connector 13 to the holder 151 of the connector stand 15, so as to release the hooking of the charging cable 14 to the hook member 26, the control unit 21 of the automatic charging robot 2 controls the drive device to move the robot arm 201 of the arm mechanism 20.

Thus, in the charging system 100 according to the third embodiment, in the operations of, for example, gripping and plugging the charging connector 13 into the charging port 53 and pulling out the charging connector 13 from the charging port 53 and returning the charging connector 13 to the holder 151 of the connector stand 15, it is possible to reduce the slack of the charging cable 14 and it is also possible to prevent the charging cable 14 from being in contact with the vehicle 5.

In the automatic charging robot and charging system according to the present disclosure, an effect can be obtained that the charging cable can be suppressed from contacting the vehicle.

According to an embodiment, in the automatic charging robot according to the present disclosure, the movement in a direction away from the arm portion of the charging cable is restricted within a predetermined range to reduce the slack. Further, it is possible to suppress the contact of the charging cable with the vehicle.

According to an embodiment, in the automatic charging robot according to the present disclosure, by hooking the charging cable to the hook member to reduce the slack of the charging cable. Further, it is possible to prevent the charging cable from being in contact with the vehicle.

According to an embodiment, in the charging system according to the present disclosure, by applying a tension by pulling the charging cable by the tensioning device, it is possible to reduce the slack of the charging cable, and it is possible to suppress the charging cable is in contact with the vehicle.

According to an embodiment, in the charging system according to the present disclosure, it is possible to suppress the charging cable from contacting the vehicle.

What is claimed is:

1. An automatic charging robot comprising:
an arm mechanism for gripping a charging connector connected to a charging device with a charging cable;
a control device for automatically performing control for operating the arm mechanism; and
a holding member for holding the charging cable along an arm portion of the arm mechanism.

2. An automatic charging robot comprising:
an arm mechanism for gripping a charging connector connected to a charging device with a charging cable;
a control device for automatically performing control for operating the arm mechanism; and
a hook member for hooking the charging cable to the arm mechanism.

3. A charging system comprising:
a charging device in which a charging connector is connected with a charging cable; and
an automatic charging robot including:
an arm mechanism for gripping the charging connector, and
a control device for automatically performing control for operating the arm mechanism, wherein
the charging cable is provided with a tensioning device for applying tension to the charging cable.

4. A charging system comprising:
a charging device in which a charging connector is connected with a charging cable, and
the automatic charging robot according to claim 1.

5. A charging system comprising:
a charging device in which a charging connector is connected with a charging cable, and
the automatic charging robot according to claim 2.
